(19) United States
(12) Patent Application Publication
(10) Pub. No.: US 2026/0142216 A1
(43) Pub. Date: May 21, 2026

(54) MANUFACTURING SYSTEM

(71) Applicant: HONDA MOTOR CO., LTD., Tokyo (JP)

(72) Inventors: Kenta Kasano, Wako-shi (JP); Takahiro Imajo, Wako-shi (JP); Hotaka Hirata, Wako-shi (JP)

(21) Appl. No.: 19/386,281

(22) Filed: Nov. 12, 2025

(30) Foreign Application Priority Data
Nov. 19, 2024 (JP) 2024-201935

(51) Int. Cl. H01M 10/04

(52) U.S. Cl. CPC H01M 10/0404

(57) ABSTRACT

A manufacturing system includes: an enclosure that is maintained at a predetermined dew point; a manufacturing apparatus of a solid-state battery, the manufacturing apparatus being stored in an inside of the enclosure; and a drive portion that is provided at a position exposed to an outside of the enclosure and operates the manufacturing apparatus.

### CROSS-REFERENCE TO RELATED APPLICATION

Priority is claimed on Japanese Patent Application No. 2024-201935, filed on Nov. 19, 2024, the contents of which are incorporated herein by reference.

### BACKGROUND

### Field Of The Invention

The present invention relates to a manufacturing system that manufactures a solid-state battery.

### Background

In the related art, in order to maintain the environment of a manufacturing line that manufactures a solid-state battery to be at a low dew point, an enclosure is constituted by sealing a manufacturing apparatus and a process apparatus with a panel such as an acrylic plate. Further, a fan is provided in the inside of the enclosure in order to perform air conditioning for the inside of the enclosure.

For example, Korean Patent Application, Publication No. 10-2022-0046333 discloses an air circulation system for manufacturing a secondary battery, which includes a clean booth that accommodates a secondary battery manufacturing apparatus in the inside of the clean booth, a main filter unit that is connected to the clean booth and suctions and decomposes a harmful gas generated at the inside of the clean booth, a dry room that accommodates the clean booth and the main filter unit, maintains a constant humidity at the inside of the dry room, and is configured so that air having a constant humidity flows into the clean booth, and a dehumidification unit that is arranged at the outside of the dry room and is configured so as to maintain a constant humidity in the dry room.

### SUMMARY

However, in the related art, there is still room for improvement in terms of maintaining an internal space of a clean booth to be in a desired atmosphere.

A problem to be solved by the present invention is to provide a manufacturing system capable of maintaining an internal space of an enclosure to be in a desired atmosphere for a long period of time.

A manufacturing system according to a first aspect of the present invention includes: an enclosure that is maintained at a predetermined dew point; a manufacturing apparatus of a solid-state battery, the manufacturing apparatus being stored in an inside of the enclosure; and a drive portion that is provided at a position exposed to an outside of the enclosure and operates the manufacturing apparatus.

According to the first aspect, since the drive portion which becomes a heat generation source at the time of operation is arranged at the outside of the enclosure, heat generated at the drive portion is easily dissipated to the outside of the enclosure. Therefore, the heat generated at the time of operation of the drive portion is prevented from transmitting to an internal space of the enclosure, and the internal space of the enclosure is easily maintained to be under a desired atmosphere for a long period of time. Further, the drive portion as a device for which it is assumed to periodically perform a maintenance or an inspection is provided to be exposed to the outside of the enclosure in advance. According to this configuration, since it becomes possible to perform the work of the maintenance or the inspection of the drive portion from the outside of the enclosure, the effort for a worker to enter and leave the inside of the enclosure is eliminated. Therefore, it is possible to prevent air in an external space of the enclosure from entering the internal space of the enclosure and prevent the dew point of the internal space of the enclosure from increasing at each time of the maintenance. As a result, it is possible to improve the maintenance property and maintain the inside of the enclosure to be at a low dew point.

A second aspect is the manufacturing system according to the first aspect described above, wherein the manufacturing apparatus may include a roll press portion that has a rotatable rotation section and presses a workpiece, and the drive portion may be a power source that drives the roll press portion which is present in the enclosure.

According to the second aspect, the drive portion that requires a large output such as the roll press portion is provided at the outside of the enclosure, and thereby, the impact of heat given to the internal space of the enclosure can be reduced. Further, since the volume of the enclosure can be also made small, a space for which an atmosphere management is required can be made small. As a result, reduction of the size, improvement of the maintenance property, and the like of an apparatus required for the atmosphere management also become possible.

A third aspect is the manufacturing system according to the first aspect described above, wherein the manufacturing apparatus may include a transportation portion that transports a workpiece, and the drive portion may be a power source that drives the transportation portion which is present in the enclosure.

According to the third aspect, it is possible to improve the degree of freedom of the transportation portion while decreasing the volume of the enclosure.

A fourth aspect is the manufacturing system according to the second or third aspect described above which may include a transmission portion that penetrates through a wall portion of the enclosure and connects the drive portion to the manufacturing apparatus, wherein the drive portion may be provided at an outside of the enclosure at a position away from the enclosure.

According to the fourth aspect, since the drive portion and the enclosure are connected via the transmission portion, the drive portion and the enclosure can be separated to a desired position. Thereby, it is possible to prevent the impact of the heat of the drive portion from reaching the internal space of the enclosure. Further, since it is also possible to prevent an abrasion powder generated at the time of operation of the drive portion, dust that is present in the external space of the enclosure, or the like from entering the internal space of the enclosure, the internal space of the enclosure is easily maintained to be under a desired atmosphere for a long period of time.

A fifth aspect is the manufacturing system according to the fourth aspect described above, wherein a seal portion may be provided on a penetration section of the enclosure in the transmission portion.

According to the fifth aspect, it is possible to maintain a seal property between the transmission portion and the wall portion of the enclosure. Thereby, the internal space of the enclosure is easily maintained to be under a desired atmosphere for a long period of time.

A sixth aspect is the manufacturing system according to any of the first to fifth aspects described above, wherein the manufacturing apparatus may include a plurality of process portions that are provided and aligned in a transportation direction of the solid-state battery, in the plurality of process portions, the size in an intersection direction that intersects the transportation direction may be different from each other, and the size in the intersection direction of the enclosure may be different depending on a position in the transportation direction in accordance with a shape of a process portion of the plurality of process portions.

According to the sixth aspect, the volume of the enclosure can be made small, for example, as compared with the case where the enclosure is formed in a rectangular parallelepiped shape by fitting the size in the intersection direction to the maximum size of the process portion. Thereby, space saving of the manufacturing system becomes possible. Further, since a space for which an atmosphere management is required can be made small, reduction of the size, improvement of the maintenance property, and the like of an apparatus required for the atmosphere management also become possible.

According to each aspect described above, it is possible to maintain the internal space of the enclosure to be in a desired atmosphere for a long period of time.

### BRIEF DESCRIPTION OF THE DRAWINGS

FIG. 1 is a cross-sectional view showing a cross section of a solid-state battery according to an embodiment.

FIG. 2 is a perspective view showing a manufacturing system according to the embodiment.

FIG. 3 is a plan cross-sectional view showing part of the manufacturing system according to the embodiment.

FIG. 4 is a perspective view showing an example of a drive portion of the manufacturing system according to the embodiment.

### DESCRIPTION OF EMBODIMENTS

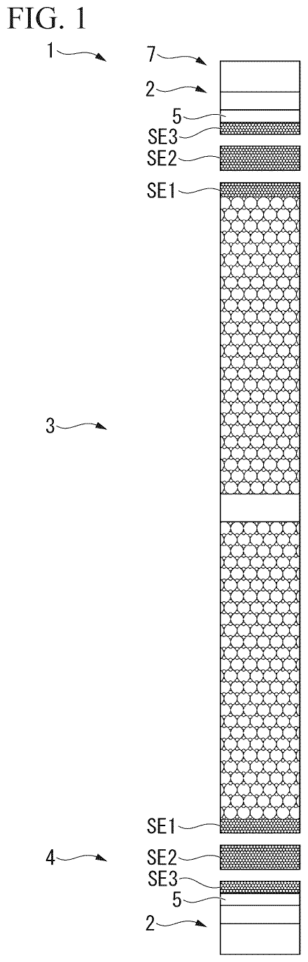

A manufacturing system of a solid-state battery according to an embodiment of the present invention will be described with reference to FIG. 1 to FIG. 4.

### Solid-State Battery 1

First, a solid-state battery 1 manufactured by a manufacturing system 10 according to the present embodiment is described with reference to FIG. 1. FIG. 1 is a cross-sectional view showing a cross section of a solid-state battery 1 according to the present embodiment.

As shown in FIG. 1, the solid-state battery 1 is an all-solid-state battery having an electrode 7 in which a negative electrode layer 2, a solid electrolyte layer 4, a positive electrode layer 3, a solid electrolyte layer 4, and a negative electrode layer 2 are laminated in this order. However, the structure of the solid-state battery 1 is not limited to the structure described above. The solid-state battery 1 may have a configuration that may be used for a solid-state battery such as an exterior body other than the electrode 7.

The solid electrolyte layer 4 in the solid-state battery 1 has at least a first solid electrolyte layer SE1 arranged on the positive electrode layer 3 side and a negative electrode side solid electrolyte layer SE3 arranged on the negative electrode layer 2 side. The solid electrolyte is constituted of an inorganic solid electrolyte such as a sulfide system electrolyte, and it is necessary to manage a dew point such that the solid electrolyte does not react with moisture. The solid electrolyte layer 4 may have a second solid electrolyte layer SE2 arranged adjacent to the first solid electrolyte layer SE1. Further, an intermediate layer 5 may be optionally arranged between the negative electrode layer 2 and the solid electrolyte layer 4. Here, since the solid electrolyte layer SE is a material of a sulfide system that is affected by moisture, a dew point management is required.

The solid-state battery 1 is not particularly limited but may be a lithium ion solid-state secondary battery or may be a lithium metal secondary battery.

### Manufacturing Process of Solid-State Battery 1)

Next, main manufacturing processes of the solid-state battery 1 are described. The process of manufacturing the solid-state battery 1 mainly includes an electrode manufacturing process and an assembly process.

The electrode manufacturing process has a kneading process of mixing an active material (battery metal), a conductive auxiliary agent, a binder, a solid electrolyte, and the like, and a coating process of coating the kneaded material on a base material such as a metal foil. It is necessary to dry the material after the coating.

The assembly process has a roll press process of smoothing a surface by compressing the coated material and forming the electrode 7 by integrating the negative electrode layer 2 and the positive electrode layer 3, and a cut process of cutting the electrode 7 for processing the electrode 7 to a predetermined size.

Further, the assembly process has a lamination process of forming the solid-state battery 1 by laminating the plurality of electrodes 7, and an end insulation process of insulating an end portion of the laminated solid-state battery 1 by performing UV coating.

Further, the assembly process has a joint process of joining a tab that functions as an electric power collection terminal to the plurality of electrodes 7 on which the UV coating is performed, and a lamination process of sealing the solid-state battery 1 by performing lamination molding.

### Manufacturing System 10

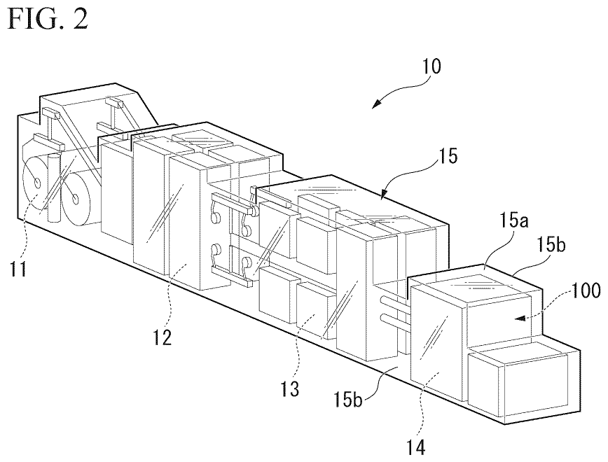

Next, the manufacturing system 10 of a solid-state battery according to the present embodiment is described with reference to FIG. 2 to FIG. 4. FIG. 2 is a perspective view showing the manufacturing system 10 according to the present embodiment.

As shown in FIG. 2, the manufacturing system 10 mainly performs the assembly process among the manufacturing processes described above. The manufacturing system 10 includes a manufacturing apparatus 100 of the solid-state battery 1, which has a plurality of process portions provided and aligned in a transportation direction of the solid-state battery 1. The manufacturing apparatus 100 includes, as a process portion, at least a wind-off machine 11, a roll press portion 12, a cut-lamination portion 13, and an end insulation portion 14. In these process portions, the size in an intersection direction (an upward-downward direction or a width direction) that intersects a transportation direction of the solid-state battery 1 is different depending on the process portion.

Further, the manufacturing system 10 includes an enclosure 15 that covers the manufacturing apparatus 100 and thereby stores the entire manufacturing apparatus 100 in the inside of the enclosure 15. The enclosure 15 partitions an internal space as an operation environment of the manufacturing apparatus 100 and an external space. The internal space of the enclosure 15 is maintained to be in an atmosphere having a low dew point (for example, −60° C. or less). The dew point management in the internal space of the enclosure 15 may be performed independently by a dehumidification device (not shown) or may be performed by using dry air used by a pretreatment device (for example, a coating process or the like) of the manufacturing system 10.

The wind-off machine 11 winds off the material of the solid-state battery 1 after the coating process to a downstream side.

The roll press portion 12 laminates, for example, the negative electrode layer 2, the intermediate layer 5, the solid electrolyte layer 4, and the positive electrode layer 3 in this order and forms the electrode 7 by integrating the negative electrode layer 2 and the positive electrode layer 3 by roll pressing.

The cut-lamination portion 13 cuts the electrode 7 generated by the roll press portion 12 in order to process the electrode 7 into a predetermined size, and forms the solid-state battery 1 by laminating the plurality of electrodes 7 that are cut. In the solid-state battery 1, for example, 27 electrodes 7 can be laminated; however, the number of electrodes 7 to be laminated is not limited to this.

The end insulation portion 14 insulates an end portion of the solid-state battery 1 laminated by the cut-lamination portion 13, for example, by performing UV coating that uses a coating material which is reacted and cured by ultraviolet irradiation and cures the coating material in a few seconds by ultraviolet irradiation of a UV lamp.

The enclosure 15 is formed, for example, by using a material having optical transparency such as an acrylic plate, and the size in the intersection direction of the enclosure 15 is different depending on a position in the transportation direction in accordance with the shape of each process portion. In an example shown in the drawing, at least a top wall 15a of the enclosure 15 is formed along an upper end position of each process portion. However, both side walls 15b in the width direction determined by a large-sized cell (workpiece W) to be transported in the enclosure 15 may be formed along both end positions in the width direction of each process portion.

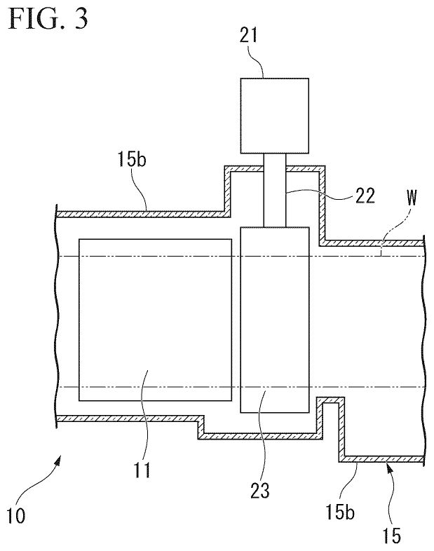

FIG. 3 is a plan cross-sectional view showing part of the manufacturing system 10. FIG. 3 shows, as an example, a portion where the roll press portion 12 is covered by the enclosure 15.

As shown in FIG. 3, in the manufacturing system 10, a drive portion 21 of the process portion is provided at the outside of the enclosure 15. In the following description, the relationship between the process portion and the drive portion 21 is described using an example of the roll press portion 12 among the process portions.

The drive portion 21 is a power source that drives a rotation section 23 of the roll press portion 12. A pair of rotation sections 23 are provided to face each other in the intersection direction. In a state where a workpiece W having a sheet form is sandwiched between the pair of rotation sections 23, the roll press portion 12 performs transportation of the workpiece W while performing a press process by the rotation of the rotation section 23.

The drive portion 21 is provided at the outside of the enclosure 15 at a position away from the enclosure 15. The drive portion 21 is, for example, a motor. The drive portion 21 and the rotation section 23 are connected by a rotation shaft 22. A speed reduction mechanism or the like may be provided between the drive portion 21 and the rotation section 23. The speed reduction mechanism may be provided at the outside of the enclosure 15 or may be provided in the internal space of the enclosure 15.

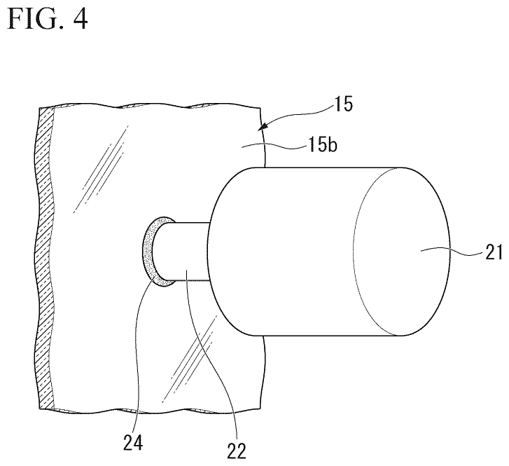

FIG. 4 is a perspective view showing an example of the drive portion 21.

As shown in FIG. 4, the rotation shaft 22 penetrates through the side wall 15b of the enclosure 15.

A seal portion 24 is provided on a penetration section of the rotation shaft 22 in the side wall 15b. The seal portion 24 can be any member as long as the member seals a gap between the rotation shaft 22 and the side wall 15b and maintains a seal performance. As the seal portion 24, for example, an elastic member such as rubber or grommet, a bearing, or the like can be used. Further, a similar seal portion can be provided on the rotation shaft 22 side.

The manufacturing system 10 according to the present embodiment includes the drive portion 21 that operating the manufacturing apparatus 100 at a position exposed to the outside of the enclosure 15.

According to this configuration, since the drive portion 21 which becomes a heat generation source at the time of operation is arranged at the outside of the enclosure 15, heat generated at the drive portion 21 is easily dissipated to the outside of the enclosure 15.

Therefore, the heat generated at the time of operation of the drive portion 21 is prevented from transmitting to an internal space of the enclosure 15, and the internal space of the enclosure 15 is easily maintained to be under a desired atmosphere for a long period of time. Further, the drive portion 21 as a device for which it is assumed to periodically perform a maintenance or an inspection is provided in a state of being exposed to the outside of the enclosure 15 in advance. According to this configuration, since it becomes possible to perform the work of the maintenance or the inspection of the drive portion 21 from the outside of the enclosure 15, the effort for a worker to enter and leave the inside of the enclosure 15 is eliminated. Therefore, it is possible to prevent air in an external space of the enclosure 15 from entering the internal space of the enclosure 15 and prevent the dew point of the internal space of the enclosure 15 from increasing at each time of the maintenance. As a result, it is possible to improve the maintenance property and maintain the inside of the enclosure 15 to be at a low dew point.

In the manufacturing system 10 according to the present embodiment, the manufacturing apparatus 100 includes a roll press portion 12 that has a rotatable rotation section 23 and presses a workpiece W, and the drive portion 21 is a power source that drives the rotation section 23.

According to this configuration, the drive portion 21 that requires a large output such as the roll press portion 12 is provided at the outside of the enclosure 15, and thereby, the impact of heat given to the internal space of the enclosure 15 can be reduced. Further, since the volume of the enclosure 15 can be also made small, a space for which an atmosphere management is required can be made small. As a result, reduction of the size, improvement of the maintenance property, and the like of an apparatus required for the atmosphere management also become possible.

The manufacturing system 10 according to the present embodiment includes a rotation shaft (transmission portion) 22 that penetrates through a side wall (wall portion) 15b of the enclosure 15 and connects the drive portion 21 to the manufacturing apparatus 100, wherein the drive portion 21 is provided at an outside of the enclosure 15 at a position away from the enclosure 15.

According to this configuration, since the drive portion 21 and the enclosure 15 are connected via the rotation shaft 22, the drive portion 21 and the enclosure 15 can be separated to a desired position. Thereby, it is possible to prevent the impact of the heat of the drive portion 21 from reaching the internal space of the enclosure 15. Further, since it is also possible to prevent an abrasion powder generated at the time of operation of the drive portion 21, dust that is present in the external space of the enclosure 15, or the like from entering the internal space of the enclosure 15, the internal space of the enclosure 15 is easily maintained to be under a desired atmosphere for a long period of time. Further, a heat source is not limited to the drive portion 21 (motor) of the roll press portion 12, and it is possible to cope with various members such as a motor which is a drive portion of the wind-off machine 11 or a drive portion that generates an upward-downward movement or vibration at the time of cutting and can be arranged at the outside.

In the manufacturing system 10 according to the present embodiment, a seal portion 24 is provided on a penetration section of the enclosure 15 in the rotation shaft 22.

According to this configuration, it is possible to maintain a seal property between the rotation shaft 22 and the wall portion 15b of the enclosure 15. Thereby, the internal space of the enclosure 15 is easily maintained to be under a desired atmosphere for a long period of time.

In the manufacturing system 10 according to the present embodiment, in the plurality of process portions, the size in an intersection direction that intersects the transportation direction is different from each other, and the size in the intersection direction of the enclosure 15 is different depending on a position in the transportation direction in accordance with a shape of a process portion.

According to this configuration, the volume of the enclosure 15 can be made small, for example, as compared with the case where the enclosure 15 is formed in a rectangular parallelepiped shape by fitting the size in the intersection direction to the maximum size of the process portion.

Thereby, space saving of the manufacturing system 10 becomes possible. Further, since a space for which an atmosphere management is required can be made small, reduction of the size, improvement of the maintenance property, and the like of an apparatus required for the atmosphere management also become possible.

Although embodiments of the present invention have been described, these embodiments have been presented as examples and are not intended to limit the scope of the invention. These embodiments can be implemented in a variety of other modes, and various omissions, combinations, substitutions, and changes can be made without departing from the scope of the invention. These embodiments and modifications thereof are included in the scope and gist of the invention and are also included in the scope of the invention described in the appended claims and equivalent thereof.

The above embodiment is described using a configuration in which the drive portion 21 is provided at a position away from the enclosure 15; however, the embodiment is not limited to this configuration. At least part of the drive portion 21 may be exposed to the outside of the enclosure 15. For example, the drive portion 21 may be provided so as to penetrate through the top wall 15a or the side wall 15b of the enclosure.

The above embodiment is described using a configuration in which the size in the intersection direction of the enclosure 15 is different depending on the position in the transportation direction in accordance with the shape of the process portion; however, the embodiment is not limited to this configuration. The size in the intersection direction of the enclosure 15 may be the size of a rectangular parallelepiped shape or the like having a size that matches the maximum size of any of the process portions.

The above embodiment is described using an example of the manufacturing system 10 used in the assembly process in the manufacturing process of the solid-state battery 1; however, the embodiment is not limited to this configuration. The manufacturing system 10 according to the present invention may be used in a process other than the assembly process.

The above embodiment is described using an example of the drive portion 21 connected to the rotation section 23 of the roll press portion 12; however, the embodiment is not limited to this configuration. The present invention is applicable to a drive portion 21 that drives each process portion of the manufacturing apparatus 100. Further, in the manufacturing apparatus 100, a drive portion that drives the transportation portion which performs transportation between the process portions may be provided at the outside of the enclosure 15. Thereby, it is possible to improve the degree of freedom of the transportation portion while decreasing the volume of the enclosure 15.

The above embodiment is described using an example of the motor as the drive portion 21; however, the embodiment is not limited to this configuration. The drive portion 21 is not limited to a portion that performs a rotation operation and may be a portion that performs a linear operation or the like.

What is claimed is:

1. A manufacturing system comprising:
an enclosure that is maintained at a predetermined dew point;
a manufacturing apparatus of a solid-state battery, the manufacturing apparatus being stored in an inside of the enclosure; and
a drive portion that is provided at a position exposed to an outside of the enclosure and operates the manufacturing apparatus.

2. The manufacturing system according to claim 1,
wherein the manufacturing apparatus comprises a roll press portion that has a rotatable rotation section and presses a workpiece, and
the drive portion is a power source that drives the roll press portion which is present in the enclosure.

3. The manufacturing system according to claim 1,
wherein the manufacturing apparatus comprises a transportation portion that transports a workpiece, and
the drive portion is a power source that drives the transportation portion which is present in the enclosure.

4. The manufacturing system according to claim 2, comprising:
a transmission portion that penetrates through a wall portion of the enclosure and connects the drive portion to the manufacturing apparatus,
wherein the drive portion is provided at an outside of the enclosure at a position away from the enclosure.

5. The manufacturing system according to claim 4,
wherein a seal portion is provided on a penetration section of the enclosure in the transmission portion.

6. The manufacturing system according to claim 1,
wherein the manufacturing apparatus comprises a plurality of process portions that are provided and aligned in a transportation direction of the solid-state battery,
in the plurality of process portions, a size in an intersection direction that intersects the transportation direction is different from each other, and
a size in the intersection direction of the enclosure is different depending on a position in the transportation direction in accordance with a shape of a process portion of the plurality of process portions.

7. The manufacturing system according to claim 3, comprising:
a transmission portion that penetrates through a wall portion of the enclosure and connects the drive portion to the manufacturing apparatus,
wherein the drive portion is provided at an outside of the enclosure at a position away from the enclosure.

8. The manufacturing system according to claim 7,
wherein a seal portion is provided on a penetration section of the enclosure in the transmission portion.

9. The manufacturing system according to claim 2,
wherein the manufacturing apparatus comprises a plurality of process portions that are provided and aligned in a transportation direction of the solid-state battery,
in the plurality of process portions, a size in an intersection direction that intersects the transportation direction is different from each other, and
a size in the intersection direction of the enclosure is different depending on a position in the transportation direction in accordance with a shape of a process portion of the plurality of process portions.

10. The manufacturing system according to claim 3,
wherein the manufacturing apparatus comprises a plurality of process portions that are provided and aligned in a transportation direction of the solid-state battery,
in the plurality of process portions, a size in an intersection direction that intersects the transportation direction is different from each other, and
a size in the intersection direction of the enclosure is different depending on a position in the transportation direction in accordance with a shape of a process portion of the plurality of process portions.
